(19) United States
(12) Patent Application Publication
(10) Pub. No.: US 2024/0184522 A1
(43) Pub. Date: Jun. 6, 2024

(54) FAST SECURE MULTIPARTY COMPARISON OPTIMIZED FOR COMMON COMPUTING ARCHITECTURES

(71) Applicant: TripleBlind, Inc., Kansas City, MO (US)

(72) Inventors: Craig GENTRY, New York, NY (US); Babak POOREBRAHIM GILKALAYE, Kansas City, MO (US); Riddhiman DAS, Parkville, MO (US)

(21) Appl. No.: 18/489,385

(22) Filed: Oct. 18, 2023

Related U.S. Application Data
(60) Provisional application No. 63/380,109, filed on Oct. 19, 2022.

(51) Int. Cl. G06F 7/02

(52) U.S. Cl. CPC G06F 7/026

(57) ABSTRACT

Systems and methods are provided for comparing a first number A^{bit} with a second number B^{bit}. A method includes receiving, from a first computing device associated with the first number A^{bit}, a share a₁^{bit} and a share b₁^{bit}; receiving, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴. The first number A^{bit}=a₁^{bit} XOR a₂^{bit} and the second number B^{bit}=b₁^{bit} XOR b₂^{bit}. The XOR operation includes an XOR function that applies addition modulo 2 to corresponding pairs of bits of two strings. The method includes comparing, via a comparison function that compares numbers as modulo 2⁶⁴, the first number A^{bit} and the second number B^{bit} to generate a shared output bit indicating which number is larger.

### PRIORITY CLAIM

The present application claims priority to U.S. Provisional Application No. 63/380,109, Oct. 19, 2022, the content of which is incorporated herein in its entirety.

### FIELD OF THE INVENTION

The present disclosure relates to a fast secure multiparty comparison approach optimized for common computing architectures.

### BACKGROUND

The comparison of two numbers is a fundamental step in many computations. For example, comparison functions can be used to compute the weights in the network where f(x)=x if x is positive and equals 0 otherwise. In particular, x can be compared to 0. As another example, both in training and evaluation, decision trees use comparisons to determine which features of the data are most relevant (e.g., provide the most information gain), and evaluate which path in the decision tree should be followed for input data.

The comparison of two numbers becomes more complicated when the numbers are encrypted, or when each of the numbers is “split” across multiple parties so that no single party can see the numbers, but collectively the parties “share” the numbers—e.g., as the sum of their shares of the numbers.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

A method of comparing a first number A^{bit} with a second number B^{bit}, the method comprising: receiving, from a first computing device associated with the first number A^{bit}, a share a₁^{bit} and a share b₁^{bit}; receiving, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴, and wherein the first number A^{bit}=a₁^{bit} XOR a₂^{bit} and wherein the second number B^{bit}=b₁^{bit} XOR b₂^{bit}, wherein XOR comprises an XOR function that applies addition modulo 2 to corresponding pairs of bits of two strings; and comparing, via a comparison function that compares numbers as modulo 2⁶⁴, the first number A^{bit} and the second number B^{bit} to generate a shared output bit indicating which number is larger.

A system for comparing a first number A^{bit} with a second number B^{bit}, the system comprising: one or more processors; and one or more computer-readable memories storing instructions which, when executed by the one or more processors, cause the one or more processors to be configured to: receive, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴, and wherein the first number A^{bit}=a₁^{bit} XOR a₂^{bit} and wherein the second number B^{bit}=b₁^{bit} XOR b₂^{bit}, wherein XOR comprises an XOR function that applies addition modulo 2 to corresponding pairs of bits of two strings; and compare, via a comparison function that compares numbers as modulo 2⁶⁴, the first number A^{bit} and the second number B^{bit} to generate a shared output bit indicating which number is larger.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE SEVERAL VIEWS OF THE DRAWINGS

The accompanying drawings are presented to aid in the description of various aspects of the disclosure and are provided solely for illustration of the aspects and not limitation thereof.

FIG. 1 illustrates the comparison of two numbers;

FIG. 2 illustrates a method aspect of this disclosure; and

FIG. 3 illustrates a computing device in according with some aspects of this disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As noted above, the comparison of two numbers fundamental to many operations. For example, neural networks often apply the ReLU function (rectified linear unit) to compute the weights in the network where ReLU(x)=x if x is positive and equals 0 otherwise. Decision trees use comparisons to determine which features of the data are most relevant (e.g., provide the most information gain), and evaluate which path in the decision tree should be followed for input data.

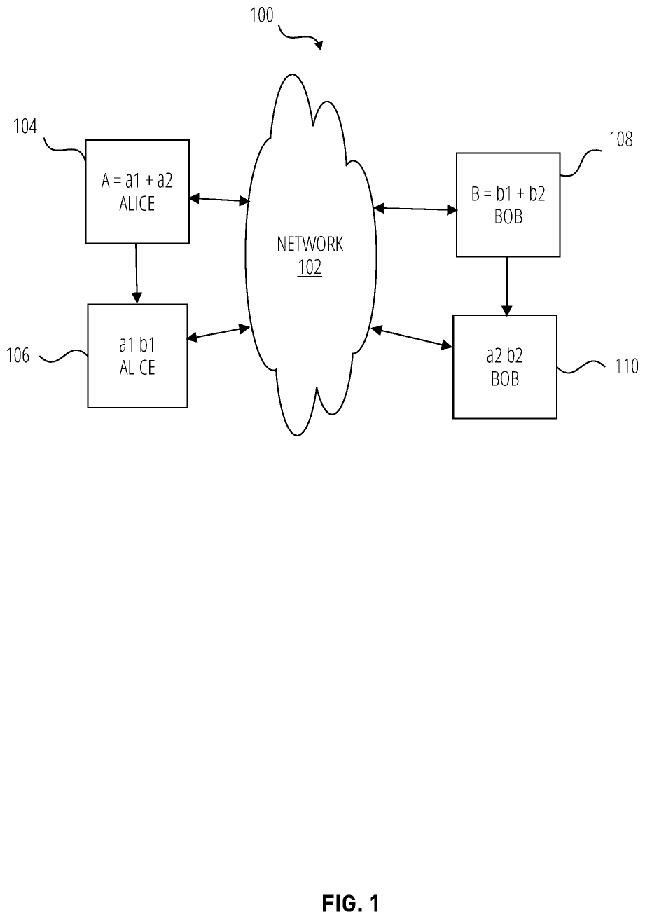

FIG. 1 illustrates a sharing system 100 in which a network 102 such as the Internet is used to enable a first computing device controlled by Alice 104 to have a value A in which A=a₁+a₂. The value A is to be compared through the network with second computing device 108 owned by Bob and that has a value B such that B=a₁+a₂. Alice 104 can generate two shares a₁+a₂ of the value A and can transmit a₂ to Bob 108. Bob 108 shares the value b₂ with Alice 104. After the sharing of numbers, Alice 106 (or the first computing device 106) is has a₁, b₁ and Bob 110 (or the second computing device 1106) has a₂, b₂. Alice 106 does not know the value of B and Bob 110 does not know the value of A. The first computing device 106 is the same as the first computing device 104 only at a later time after which shared values are exchanged. The second computing device 1110 is the same as the second computing device 108 only at a later time after which shared values are exchanged.

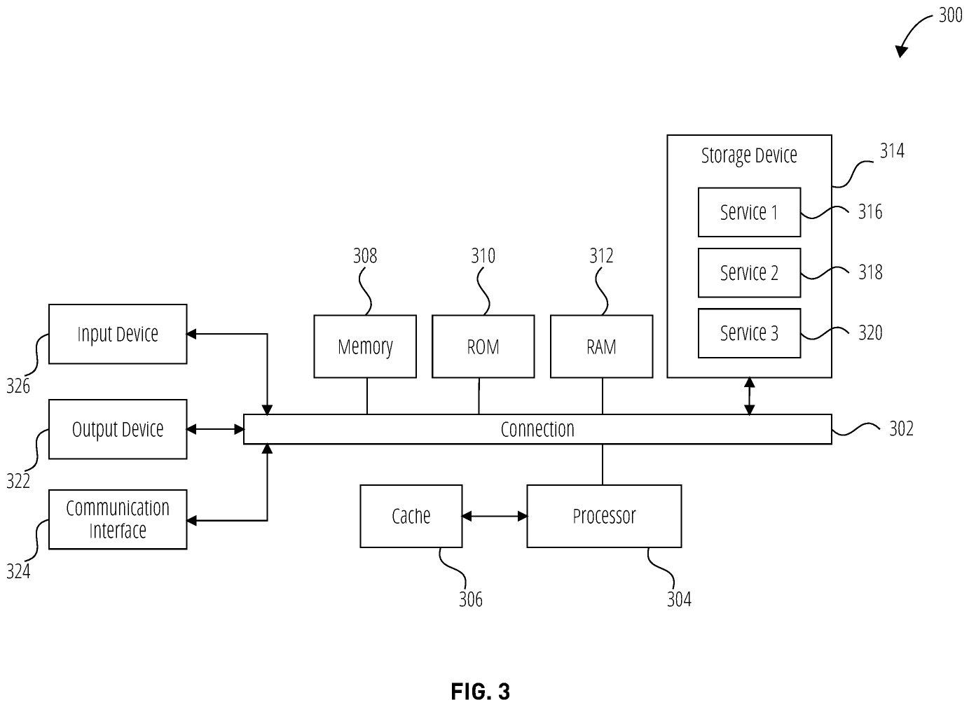

Note that the “system” as disclosed herein can include a single computing device as in the computing system 300 shown in FIG. 3, or it may include the first computing device (used by Alice) 106 and the second computing device 110 (used by Bob). In some cases, the different computing devices are owned or operated by different entities and thus it is noted that all the features or operations described herein can be implemented from the standpoint of a single one of the computing devices 106, 110 in the overall system 100.

The equalities disclosed may hold modulo some number. For example, the equation A=a₁+a₂, mod 2⁶⁴ means that A−(a₁+a₂) is a multiple of 2⁶⁴. This disclosure may not always refer to the modulus explicitly, and it is understood that it need not always be 2⁶⁴. The purpose of “sharing” a number across several parties in this way is so that no single party learns the number. In fact, the numbers a₁, b₁, a₂, b₂ can be chosen randomly so that, from Alice's perspective, Alice's shares a₁, b₁ are numbers that appear completely random and independent (modulo 2⁶⁴ for example) from the numbers A and B, and therefore Alice's shares convey absolutely no information about A and B. Bob's shares, from his perspective, similarly appear to the random and independent. Of course, someone who views all of the shares a₁, b₁, a₂, b₂ can see that they correspond to A and B (by the equations above), but Alice 106 and Bob 110 in isolation each see only half of the shares, which (in isolation) appear completely independent of A and B.

Despite the fact that each party holds shares that appear—to each party in isolation—to be random and independent, the approach is to enable the parties to compare their shared numbers A and B. The innovation described here is an especially efficient secure multiparty computation (SMPC) method for determining which number is larger without revealing anything at all about these numbers, besides the result of the comparison. Even the final result of the comparison need not be revealed but can be held as a value “split” or “shared” among the parties of the comparison protocol.

In some aspects, this disclosure addresses the case where A and B are two numbers that fit in 64-bit words. Specifically, each number is mapped modulo 2⁶⁴ into the range [−2⁶³, 2⁶³−1]. The case is addressed where A and B are each shared between Alice and Bob as shown in FIG. 1. Alice 106 holds shares a₁, b₁ and Bob 110 holds shares a₂, b₂, where a₁, b₁, a₂, b₂ are also 64-bit numbers in the range [−2⁶³, 2⁶³−1] satisfying the equations: A=a₁+a₂ mod 2⁶⁴ and B=b₁+b₂ mod 2⁶⁴.

The approach has two main components. The first component is a protocol, called COMPARE-Z. The COMPARE-Z protocol takes as input two 64-bit shares a₁^{bit}, b₁^{bit} held by Alice 106 and two 64-bit shares A^{bit}=a₁^{bit} XOR a₂^{bit} and B^{bit}=b₁^{bit} XOR b₂^{bit}, where XOR is the XOR function that applies addition modulo 2 to the corresponding pairs of bits of two strings. Notice that it is preferred that the values A^{bit} and B^{bit} are shared bit-by-bit via XOR instead of modulo 2⁶⁴.

The protocol COMPARE-Z will output a shared bit indicating the result of the comparison. That is, interpreting the 64-bit strings A^{bit} and B^{bit} as numbers modulo 2⁶⁴, the shared output bit will indicate which numbers is larger. The innovation here is the extreme efficiency of the disclosed approach, which includes two features: (1) a very simple, natural, and minimally-complex multivariate polynomial is used to represent the comparison function in terms of the individual bits of A^{bit} and B^{bit}, and (2) the approach evaluates the polynomial using a recursive approach that takes advantage of fast in-built 64-bit processor instructions such as XOR, AND, and shift. Moreover, the recursive approach allows more and more intermediate results of the comparisons to be compressed together into a 64-bit word as the recursive protocol progresses, which reduces the overall complexity of the computation. Note that all of these optimizations work despite the fact that the numbers are shared. The second component of the disclosed approach is an almost cost-free reduction of our initial problem—comparing A and B when Alice 106 and Bob 110 hold shares of them modulo 2⁶⁴—to the problem solved by COMPARE-Z—comparing A^{bit} and B^{bit} when Alice 106 and Bob 110 hold them as 64 shares modulo 2.

This component adjusts the result of COMPARE-Z based on the topmost bit of the shares held by Alice 106 and Bob 110.

Comparing two 64-Bit numbers that are shared bit-wise first using the COMPARE-Z component of the comparison protocol is discussed next. Suppose there are two 64-bit strings A^{bit} and B^{bit}. The system will determine whether A^{bit}≥B^{bit} when these 64-bit strings are interpreted as integers in the range [−2⁶³, 2⁶³−1]. One can write out the binary representation of these numbers: A^{bit}=A₆₃^{bit}, . . . , A₀^{bit} and B^{bit}=B₆₃^{bit}, . . . , B₀^{bit}. Suppose that these are numbers in the range [0, 2⁶⁴−1]. Note that the system only needs to make slight adjustments for the range [−2⁶³, 2⁶³−1]. Then, the result is that A^{bit}>B^{bit} if and only if Aᵢ^{bit}>Bᵢ^{bit} where i is the index of the most significant bit at which A^{bit} and B^{bit} differ.

One can express this condition as a polynomial as follows: COMPARE-Z(A^{bit}, B^{bit})=y₆₃+x₆₃ y₆₂+x₆₃ x₆₂ y₆₁+ . . . x₆₃ . . . x₁ y₀. Consider why the formula is correct. Notice that, for any i, it is impossible for both yᵢᵢ and xᵢ to be nonzero when Aᵢ^{bit}, Bᵢ^{bit}∈{0, 1}. Therefore, at most, one of the monomials in the above polynomial can be nonzero. If, for example x₆₃ x₆₂ . . . x₍ᵢ₊₁₎yᵢ is nonzero, it indicates that A^{bit} and B^{bit} have the same most significant bits, until the i-bit where Aᵢ^{bit}=1 and Bᵢ^{bit}=0, in which case A>B. The various monomials in the polynomial above partition the possible positions where Aᵢ^{bit} and Bᵢ^{bit} begin to differ, and overall the polynomial computes the comparison function correctly. This is in fact the minimally-complex that takes the binary representations of two numbers as input and outputs the result of their comparison.

Moreover, the polynomial above can be computed very quickly using a recursive approach. Specifically, one can define the following two polynomials: pₙ(x₍ₙ₋₁₎, . . . , x₀, y₍ₙ₋₁₎, . . . , y₀)=y₍ₙ₋₁₎+x₍ₙ₋₁₎ y₍ₙ₋₂₎+x₍ₙ₋₁₎ x₍ₙ₋₂₎ y₍ₙ₋₃₎+ . . . +x₍ₙ₋₁₎ . . . x₁ y₀ qₙ(x₍ₙ₋₁₎, . . . , x₀, y₍ₙ₋₁₎, . . . , y₀)=x₍ₙ₋₁₎ x₍ₙ₋₂₎ . . . x₁ x₀. In particular, pₙ is precisely the comparison function, as explained above, and qₙ can be simply the product of the bits in x. Observe that pₙ(x₍ₙ₋₁₎, . . . , x₀, y₍ₙ₋₁₎, . . . , y₀)=p_{(n/2)} (x₍ₙ₋₁₎, . . . , x_{(n/2)}, y₍ₙ₋₁₎, . . . , y_{(n/2)})+q_{(n/2)}(x₍ₙ₋₁₎, . . . , x_{(n/2)}, y₍ₙ₋₁₎, . . . , y_{(n/2)})·p_{(n/2)}(x_{(n/2-1)}, . . . , x₀, y_{(n/2-1)}, . . . , y₀) qₙ(x₍ₙ₋₁₎, . . . , x₀, y₍ₙ₋₁₎, . . . , y₀)=q_{(n/2)}(x₍ₙ₋₁₎, . . . , x_{(n/2)}, y₍ₙ₋₁₎, . . . , y_{(n/2)})+·q_{(n/2)}(x_{(n/2-1)}, . . . , x₀, y_{(n/2-1)}, . . . , y₀). A recursive module or engine for example implemented as a computing device or software programmed to control a processor to perform a recursive approach to computing the data can be implemented.

That is, one can decompose the computation of pₙ and qₙ in terms of computations of p_{(n/2)} and q_{(n/2)} over the most significant half of the bits and the least significant half. For example, when n=64, the computation of p₆₄ and q₆₄ decomposes as two computations each of p₃₂ and q₃₂ which are then combined through addition and/or multiplication to obtain the final results. Each computation of p₃₂ and q₃₂, in turn, decomposes into two computations of p₁₆ and q₁₆ (and then an aggregation step), and so on, until at the “bottom” of the recursion process one can run 32 instances of p₂ and q₂ that compute y₍₂ᵢ₊₁₎+x₍₂ᵢ₋₁₎y₂ᵢ and x₍₂ᵢ₊₁₎·x₂ᵢ for all i∈[0, 31]. While 32 instances of p₂ and q₂ may initially sound expensive, one can batch them—that is, compute them simultaneously in a SIMD (single instructions, multiple data) fashion—in a small number of operations on 64-bit words. Computer processors 304 typically use a 64-bit architecture, and come up equipped with fast instructions, such as taking the XOR of two 64-bit words, taking their AND (multiplying each pair of corresponding bits from two 64-bit words and putting the result in another 64-bit word) and shift (which can shift the bits in a word left or right).

This disclosure exploits these fast instructions to make the above computations in a SIMD fashion wherein the computations are fast and in parallel. Specifically, the processor 304 can compute q₂(x₍₂ᵢ₊₁₎, y₂ᵢ, y₍₂ᵢ₊₁₎, y₂ᵢ) for all i∈[0, 31] simultaneously by computing x⁽²⁾:=x AND shiftright1(x)—that is, the system apply the 64-bit AND operation to x and the string x shifted right by 1 position, so that the bit in the i^{th} position of x is in the (i−1)^{th} position of shiftright1(x). Now bit positions 2ᵢ of x⁽²⁾ for i∈[0, 31] hold the value x₍₂ᵢ₊₁₎x₂ᵢ. Next, to compute q₄(x₍₂ᵢ₊₃₎, . . . , x₂ᵢ, y₍₂ᵢ₊₃₎, . . . , y₂ᵢ)) for all i∈[0, 15], the system sets x⁽⁴⁾:=x⁽²⁾ AND shiftright2(x⁽²⁾). Now bit positions 4ᵢ for i∈[0, 15] hold the value x₍₄ᵢ₊₃₎ . . . x₄ᵢ. The system can stop this process when it has computed x⁽³²⁾. Altogether, the system needs only five fast instructions on 64-bit words to compute all of the outputs of the q polynomials that are needed in the computation. The system computes the outputs of p polynomials similarly. Because the outputs of the p polynomials are always in {0, 1}, it suffices to compute the results modulo 2, and therefore the system can replace the + operations in the p polynomials with XOR operations.

In the 0-th step of the recursion, the system starts with x⁽¹⁾=x and y⁽¹⁾=y. In the k-th step in the recursion, the system starts with x⁽²^{^{k−1}}⁾ and y⁽²^{^{k−1}}⁾ where the latter has the various results of p₂_{^{k−1}} in it in positions 2^{k-1}i. The system then computes as equation (1):

y⁽²^{^{k}}⁾:=shiftright2^{k-1}(y⁽²^{^{k−1}}⁾) XOR (x⁽²^{^{k−1}}⁾ AND y⁽²^{^{k−1}}⁾) (1)

For 64-bit words, the system needs to obtain the final result of the comparison as y⁽²^{⁶}⁾ in position 0. This disclosure has described a very efficient COMPARE-Z method for computing the comparison function, but it has not yet been described how to perform COMPARE-Z when the integers A and B are shared. In particular, one can use the “Beaver triples” technique to convert a circuit of XORs (additions) and ANDs (multiplications) into a secure multiparty computation (SMPC) protocol that evaluates a circuit securely. SIMD techniques can also use here. In some aspects, the protocol for 64-bit words can use a Beaver triple that consists of three 64-bit strings R, S, T such that T=R AND S. That is, R, S, T are equivalent to 64 Beaver triples over the field GF(2). The field GF(2) represents a Galois extension field of order 2ⁿ which are different to computation modulo 2ⁿ. Notably, every element has an inverse which is not the case in modulo 2ⁿ. These triples are XOR shared between the parties and employed in the usual way. The shift operations described above are implemented by performing the same shift operations separately on the separate shares held by the parties.

In sum, the COMPARE-Z ([A^{bit}], [B^{bit}]) takes as input sharings [A^{bit}]=(a₁^{bit}, a₂^{bit}) and [B^{bit}]=(b₁^{bit}, b₂^{bit}) satisfying A^{bit}=a₁^{bit} XOR a₂^{bit} and B^{bit}=b₁^{bit} XOR b₂^{bit} (where Alice 106 holds (a₁^{bit}, b₁^{bit}) and Bob 110 holds (a₂^{bit}, b₂^{bit})). The operation outputs a sharing of 1 if A^{bit}>B^{bit} and a sharing of 0 otherwise. During the computation, using pre-prepared Beaver triples, Alice 106 and Bob 110 use SMPC operations for each XOR and AND gate of the recursively computed comparison circuit described above.

Additional optimizations to Compare-Z are discussed next, including a compression concept. Recall that, after k steps of the recursion in COMPARE-Z, only the bits in positions 2^{k}i for i∈[0, 2^{6-k}−1] carry “useful” information. The other bit positions hold values that are not used in the comparison computation. This seems wasteful. There is a way that the system can put these unused positions in memory to work.

Suppose one wishes to do many comparisons of 64-bit numbers, not just a single comparison. For example, suppose the system has two pairs of numbers—A⁽⁰⁾ and B⁽⁰⁾, A⁽¹⁾ and B⁽¹⁾—and one wants to compute both COMPARE-Z ([A⁽⁰⁾], [B⁽⁰⁾]) and COMPARE-Z ([A⁽¹⁾], [B⁽¹⁾]). Separately, one can run the first step of the recursive algorithm to obtain words that hold the relevant values of q₂ and p₂ lodged in bit positions 2i for i∈[0, 31]. Again, only half of the bits in these words will be used in the rest of the comparison computation. Fortunately, one can merge the words together for better efficiency. For example, suppose w⁽⁰⁾ and w⁽¹⁾ are the words that holds the relevant values of q₂ associated with the comparisons of (A⁽⁰⁾, B⁽⁰⁾) and (A⁽¹⁾, B⁽¹⁾) respectively. These values are lodged in positions 2i for i∈[0, 31] in w⁽⁰⁾ and w⁽¹⁾ respectively. The system can apply a shiftleft1 to the word w⁽¹⁾ and, for bit positions 2i+1 with for i∈[0, 31], one can replace w⁽⁰⁾'s bits with w⁽¹⁾'s bits. That is, the system now has a packed word w that has 32 q₂ values for w⁽⁰⁾ in positions 2i and 32 q₂ values for w⁽¹⁾ in positions 2i+1. The system can continue the recursion operation as before. Eventually, the system ends up with the results of the comparisons in bit positions 0 (for the (A⁽⁰⁾, B⁽⁰⁾) comparison) and 1 (for the (A⁽¹⁾, A⁽¹⁾) comparison).

But one can pack even more data into the process. After the system merges the q₂ results as described above, and then performs the comparisons, one again is using only half of the bits of each resulting word. So, the system can merge again. Assuming one is trying to evaluate at least four comparisons, the system merges the first and second pairs of comparisons after computing their q₂ values, and the system merges the merged results into a single word after computing the q₄ results. Then, again, the system can continue the result of the recursion as before, where the final comparison results would end up in position 0, . . . , 3.

Furthermore, the system can continue to merge. Assuming the system is performing at least 64 comparisons, the system can merge results after each step in the recursion so that eventually the results of all 64 comparisons end up in a single word. This approach reduces both memory and computation as the recursion progresses.

Next is discussed alternative compression and pipelining concepts. The compression approach above reduces memory usage by half for each step of the recursion. If there is a fixed amount of memory, and one would like to pipe many comparisons through that memory so as to maximize throughput. The following describes another approach to compression.

The invariant that the system can maintain in this approach is that, at the beginning of a step, a single 64-bit word will hold results associated with six different comparisons, where (roughly speaking) the six comparisons are at six different steps in their recursive computation. One can focus on the first on the word that holds the results of the q polynomials (the x monomials) associated with the six comparisons (the word for the p polynomials is analogous). Specifically, in word w:
1. Positions 32 through 63 will hold the 32 most significant bits of the value of x associated with comparison 1.
2. Positions 16 through 31 will hold the 16 q₂ results (i.e., the results of the first recursive step applied to the first 32 bits of x) associated with comparison 2.
3. Positions 8 through 15 will hold the 8 q₈ results (i.e., the results of the second recursive step) associated with comparison 3.
4. Positions 4 through 7 will hold the 4 q₈ results (i.e., the results of the third recursive step) associated with comparison 4.
5. Positions 2 through 3 will hold the 2 q₁₆ results (i.e., the results of the fourth recursive step) associated with comparison 5.
6. Positions 1 will hold the q₃₂ result (i.e., the results of the fifth recursive step) associated with comparison 6.

First, the system saves the result in position 1 elsewhere. Next, the system computes w′:=w AND shiftright1(w). Positions 2i of w′ now contain the information one would like to keep. Next, the system constructs w″ by moving the bit at position 2i to position i, so that this information is in positions [0, 31]. Finally, the system moves the 32 least significant bits associated with a new comparison (comparison 7) into positions [32, 63]. At the end, the system has a new w′″ where the invariant has been maintained, except now the results are associated with comparisons 2 through 7 rather than 1 through 6. One can do something similar with the p polynomials. In particular, the system uses the above approach twice, once for the 32 least significant bits of the y values associated with a comparison, and once for the 32 most significant bits. The final results of the comparisons are obtained from the bits that come “off the assembly line” from position 1, and these final computations can be batched as well. The advantage of this approach is that it fully employs a constant amount of memory as comparisons are piped through, and also fully employs the parallel computation capability of the system.

While Beaver triples are mentioned above, there are variations to using Beaver triples that can be used as well. A modified approach to Beaver triples can be used to reduce the amount of communication, and can even reduce the number of rounds, involved in the comparison protocol.

Suppose A and B are two 64-bit integers in the range [−2⁶²+1, 2⁶²−1]. Assume further that one has mod-2⁶⁴ sharings of these numbers between two parties Alice 106 and Bob 110—that is, Alice 106 holds a₁, b₁∈[−2⁶³, 2⁶³−1] and Bob 110 holds a₂, b₂∈[−2⁶³, 2⁶³−1] such that A=a₁+a₂ mod 2⁶⁴ and B=b₁+b₂ mod 2⁶⁴. They now want to run a SMPC protocol to determine whether A>B, using COMPARE-Z as a sub-protocol. Here, one describes such a protocol, COMPARE, that requires only a single invocation of COMPARE-Z.

In this approach, roughly speaking, the system will compute (sharings of) D=A−B and check whether D>0:
1. First, the parties compute shares of D=A−B. That is, Alice 106 computes d₁=a₁−b₁ mod 2⁶⁴ and Bob 110 computes d₂=a₂−b₂ mod 2⁶⁴ where again reduction is into the range [−2⁶³, 2⁶³−1]. It is important that A, B∈[−2⁶²+1, 2⁶²−1] to guarantee D is in [−2⁶³+2, 2⁶³−2].
2. They (Alice and Bob) set sᵢ:=(dᵢ<0) for i=1, 2.
3. Each party creates two shares of its own sᵢ over [symbol] ₂ and sends one share to the other party.
4. Alice and Bob separately compute:

kᵢ=sᵢ(2⁶³−1)+dᵢ
5. Each party creates binary shares of kᵢ and sends it to the other party. That is, Alice 106 generates a random XOR sharing of k₁ (that is, the binary representation of k₁) and keeps one share to herself and gives the other to Bob 110. Bob 110 does analogous operations for k₂. The parties use SMPC to compute:

[r]=COMPARE−Z([k₁], [k₂])
6. The parties (Alice 106 and Bob 110) compute [result]=[r]+[s₁]+[s₂] mod 2.

The correctness of the reduction is discussed next. Recall some facts from above that can be used to prove correctness:
1. A, B∈[−2⁶²+1, 2⁶²−1] and D=A−B.
2. a₁, a₂, b₁, b₂, d₁, d₂∈[−2⁶³, 2⁶³−1] such that A=a₁+a₂ mod 2⁶⁴, B=b₁+b₂ mod 2⁶⁴, d₁=a₁−b₁ mod 2⁶⁴, d₂=b₂−a₂ mod 2⁶⁴, and D=d₁−d₂ mod 2⁶⁴.

To prove correctness, one can consider the various cases of d₁ and d₂ being negative or positive.

Case 1: d₁ and d₂ have the same sign Suppose d₁ and d₂ are both ≥0 or both <0. In this case, d₁−d₂ is already in the range [−2⁶³, 2⁶³−1] without any reduction modulo 2⁶⁴. That is, D=d₁−d₂ over [symbol] . So:

$$\begin{matrix}COMPARE - Z ( A , B ) = COMPARE - Z ( A - B , 0 ) \\ = COMPARE - Z ( D , 0 ) \\ = COMPARE - Z ( {d}_{1} - {d}_{2} , 0 ) \\ = COMPARE - Z ( {d}_{1} , {d}_{2} )\end{matrix}$$

If d₁≥0 and d₂≥0, one can have s₁=0, s₂=0, k₁=d₁, k₂=d₂ and result=COMPARE−Z(k₁, k₂)=COMPARE−Z(d₁, d₂), which is correct.
If d₁<0 and d₂<0, one can have s₁=1, s₂=1, k₁=d₁+2⁶³−1, d₂+2⁶³−1, k₂=d₂+2⁶³−1, and result=COMPARE−Z(k₁, k₂)=COMPARE−Z(d₁+2⁶³−1, d₂+2⁶³−1)=COMPARE−Z(d₁, d₂), which is correct.

Notice that some of these equalities underlying correctness rely on the numbers not overflowing the interval [−2⁶³, 2⁶³−1]. For example, in the second case above, one can establish that d₁<0 and d₂<0 and both are in [−2⁶³, 2⁶³−1]. In that case k₁=d₁+2⁶³−1, k₂=d₂+2⁶³−11 are also both in [−2⁶³, 2⁶³−1]. If one had added 2⁶³−1 to d₁ and d₂ and the result of one addition overflowed (was bigger than 2⁶³−1, necessitating subtracting 2⁶⁴ to get it back in the proper range) while the other addition did not overflow, then comparing the two resulting numbers over the integers [symbol] would give a different result than comparing the original numbers d₁, d₂,—leading to incorrectness.

Case 2: d₁≥0 and d₂<0

One can have s₁=0, s₂=1, k₁=d₁, k₂=d₂+2⁶³−1, and

result=1+COMPARE−Z(k₁, k₂)=1+COMPARE−Z(d₁, d₂+2⁶³−1)
If d₁−d₂≤2⁶³−1, then result=1 as computed above. This is correct, since in this case D=d₁−d₂ without any wrapping modulo 2⁶⁴ and therefore D is positive, meaning that indeed A>B.
If d₁−d₂>2⁶³−1, then result=0 as computed above. This is correct, since in this case the system must have D=d₁−d₂−2⁶⁴, which must be negative, meaning that it is false that A>B.

Case 3: d₁<0 and d₂≥0

One can have s₁=1, s₂=0, k₁=d₁+2⁶³−1, k₂=d₂, and

result=1+COMPARE−Z(k₁, k₂)=1+COMPARE−Z(d₁, 2⁶³−1, d₂)
If d₁−d₂>2⁶³+1, then result=0 as computed above. This is correct, since in this case D=d₁−d₂ without any wrapping modulo 2⁶⁴ and therefore D is negative, meaning that it is false that A>B.
If d₁−d₂≤−2⁶³+1, then result=1 as computed above. This is correct, since in the fact that A, B∈[−2⁶²+1, 2⁶²−1] implies that D≥−2⁶³+2. Therefore, it must hold that D=d₁−d₂+2⁶⁴, and therefore D is positive, meaning that indeed A>B.

The use of a multiparty protocol is described next. Above is described in detail how COMPARE works when two parties, called Alice and Bob, hold shares of the numbers to be compared. Here, this disclosure explains how to extend COMPARE to parties for arbitrary n.

Let A=a₁+ . . . +aₙ mod 2⁶⁴ and B=b₁+ . . . +bₙ mod 2⁶⁴+where party Pᵢ holds shares (aᵢ, bᵢ). Let D=A−B, as before. The approach consists of two parts:
Step 1: From the mod-2⁶⁴ sharings, the parties obtain bit-sharings of two numbers d₁, d₂ such that D=d₁−d₂ mod 2⁶⁴.
Step 2: Given the shares d₁, d₂, we proceed basically as before. From d₁, d₂, compute s₁, s₂, k₁, k₂ using SMPC, then compute COMPARE-Z(k₁, k₂) and finally the result of the comparison.

Step 1 includes several features. If each party Pᵢ simply secret-shared its shares aᵢ, bᵢ—that is, it XOR-shared aᵢ and bᵢ among the n parties—then the n parties would have bit-wise sharings of 2n numbers—namely, aᵢ, . . . , aₙ, −b₁, . . . , −bₙ—whose sum is D modulo 2⁶⁴. The problem now is to reduce the number of numbers in the sum from 2n to 2.

To solve this problem, the system can use the so-called 3-for-2 trick. The 3-for-2 trick takes 3 numbers in binary representations—for example, r=(rₖ, . . . , r₀), s=(sₖ, . . . , s₀), t=(tₖ, . . . , t₀).—and outputs 2 numbers in binary representation that have the same sum as the original three numbers. Specifically, the first number is simply the XOR of the three numbers: u=r XOR s XOR t. The second number holds all of the “carry” bits from the addition of the three numbers: v=shiftleft1(v′) where v′=(r AND s) XOR (r AND t) XOR (s AND t). It can be verified that the numbers represented by u, v have the same sum as the numbers represented by r, s, t. Each application of the 3-for-2 trick reduces the number of numbers by 1, so 2n−2 applications of the trick are needed to reduce the number of numbers from 2n to 2.

Observe that many triples can be reduced to doubles in parallel. Also, observe that one can reduce communication significantly by not first n-wise sharing the initial values. Rather, for example, small sub-groups of parties can share within the sub-group and each subgroup separately can work to reduce the number of numbers that they are sharing. Once the small subgroups have reduced their number of numbers, they can cross-share with another group (or groups). This merging temporarily increases the number of numbers that are being shared in the group. But they work again to reduce the number of numbers. And so on, until the entire group is sharing only two numbers.

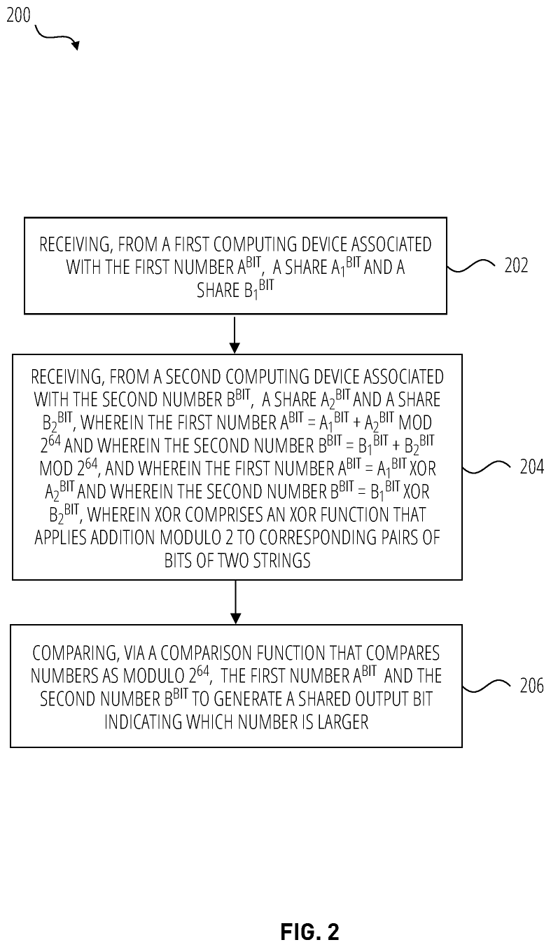

FIG. 2 illustrates a method 200 related to comparing a first number A^{bit} with a second number B^{bit}. The method can be performed by a “system” which can include one or more computing devices 300 such as is shown in FIG. 3 and/or FIG. 1. The method 200 can include receiving, from a first computing device associated with the first number A^{bit}, a share a₁^{bit} and a share b₁^{bit} (202) and receiving, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴, and wherein the first number A^{bit}=a₁^{bit} XOR a₂^{bit} and wherein the second number B^{bit}=b₁^{bit} XOR b₂^{bit}, wherein XOR comprises an XOR function that applies addition modulo 2 to corresponding pairs of bits of two strings (204). The method 200 can further include comparing, via a comparison function that compares numbers as modulo 2⁶⁴, the first number A^{bit} and the second number B^{bit} to generate a shared output bit indicating which number is larger (206).

In some aspects, the first number A^{bit} can include a first 64-bit word and the second number B^{bit} comprises a second 64-bit word. The share a₁^{bit} is in a 64-bit format and the share b₁^{bit} is in the 64-bit format.

The XOR function can compare a₁^{bit} with a₂^{bit} and b₁^{bit} with b₂^{bit} on a bit-by-bit basis and not under modulo 2⁶⁴. In another aspect, the comparison function can be represented as a multivariate polynomial in terms of individual bits of A^{bit} and B^{bit}. The comparison function in such a case applies a recursive approach to evaluate the multivariate polynomial.

In some aspects, the comparing, via the comparison function that compares numbers as modulo 2⁶⁴, the first number A^{bit} and the second number B^{bit} to generate the shared output bit indicating which number is larger occurs on each of the first computing device and the second computing device (e.g., the first computing device 106 and the second computing device 110).

In some aspects, the comparison function can apply a Beaver triples technique that converts a circuit of additions and multiplications into a secure multi-party computation protocol that evaluates the circuit securely. The Beaver triples technique in one example uses three 64-bit strings R, S, T such that T−R AND S. The triples R, S and T can be equivalent to 64 Beaver triples over a field GF(2).

In other aspects, the comparing can be performed using pre-prepared Beaver triples and the first computing device and the second computing device use secure multi-party computation operations for each XOR and AND gate of the comparison function. The comparison function can be implemented as a recursively computed comparison circuit.

In some aspects, a system (e.g., the computing device 300 and/or a combination of the first computing device 106 and the second computing device 110) for comparing a first number A^{bit} with a second number B^{bit}. The system includes one or more processors and one or more computer-readable memories storing instructions. When the instructions are executed by the one or more processors, the instructions cause the one or more processors to be configured to: receive, from a first computing device associated with the first number A^{bit}, a share a₁^{bit} and a share b₁^{bit}; receive, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴, and wherein the first number A^{bit}=a₁^{bit} XOR a₂^{bit} and wherein the second number B^{bit}=b₁^{bit} XOR b₂^{bit}, wherein XOR comprises an XOR function that applies addition modulo 2 to corresponding pairs of bits of two strings; and compare, via a comparison function that compares numbers as modulo 2⁶⁴, the first number A^{bit} and the second number B^{bit} to generate a shared output bit indicating which number is larger.

In some aspects, the first number A^{bit} can include a first 64-bit word and the second number B^{bit} comprises a second 64-bit word. The share a₁^{bit} is in a 64-bit format and the share b₁^{bit} is in the 64-bit format.

The XOR function can compare a₁^{bit} with a₂^{bit} and b₁^{bit} with b₂^{bit} on a bit-by-bit basis and not under modulo 2⁶⁴. In another aspect, the comparison function can be represented as a multivariate polynomial in terms of individual bits of A^{bit} and B^{bit}. The comparison function in such a case applies a recursive approach to evaluate the multivariate polynomial.

In some aspects, the comparing, via the comparison function that compares numbers as modulo 2⁶⁴, the first number A^{bit} and the second number B^{bit} to generate the shared output bit indicating which number is larger occurs on each of the first computing device and the second computing device (e.g., the first computing device 106 and the second computing device 110).

In some aspects, the comparison function can apply a Beaver triples technique that converts a circuit of additions and multiplications into a secure multi-party computation protocol that evaluates the circuit securely. The Beaver triples technique in one example uses three 64-bit strings R, S, T such that T−R AND S. The triples R, S and T can be equivalent to 64 Beaver triples over a field GF(2).

In other aspects, the comparing can be performed using pre-prepared Beaver triples and the first computing device and the second computing device use secure multi-party computation operations for each XOR and AND gate of the comparison function. The comparison function can be implemented as a recursively computed comparison circuit.

FIG. 3 shows an example of computing system 300, which can be for example any computing device used to compare two number, or any component thereof including components of the system that are in communication with each other using connection 302. Connection 302 can be a physical connection via a bus, or a direct connection into processor 304, such as in a chipset architecture. Connection 302 can also be a virtual connection, networked connection, or logical connection.

In some embodiments, computing system 300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 300 includes at least one processing unit (CPU or processor) 304 and connection 302 that couples various system components including system memory 308, such as read-only memory (ROM) 310 and random access memory (RAM) 312 to processor 304. Computing system 300 can include a cache of high-speed memory 306 connected directly with, in close proximity to, or integrated as part of processor 304.

Processor 304 can include any general purpose processor and a hardware service or software service, such as services 316, 318, and 320 stored in storage device 314, configured to control processor 304 as well as a special-purpose processor where software instructions are incorporated into the actual processor design. Processor 304 may essentially be a completely self-contained computing system, containing multiple cores or processors, a bus, memory controller, cache, etc. A multi-core processor may be symmetric or asymmetric.

To enable user interaction, computing system 300 includes an input device 326, which can represent any number of input mechanisms, such as a microphone for speech, a touch-sensitive screen for gesture or graphical input, keyboard, mouse, motion input, speech, etc. Computing system 300 can also include output device 322, which can be one or more of a number of output mechanisms known to those of skill in the art. In some instances, multimodal systems can enable a user to provide multiple types of input/output to communicate with computing system 300. Computing system 300 can include communication interface 324, which can generally govern and manage the user input and system output. There is no restriction on operating on any particular hardware arrangement, and therefore the basic features here may easily be substituted for improved hardware or firmware arrangements as they are developed.

Storage device 314 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 314 can include software services, servers, services, etc., that when the code that defines such software is executed by the processor 304, it causes the system to perform a function. In some embodiments, a hardware service that performs a particular function can include the software component stored in a computer-readable medium in connection with the necessary hardware components, such as processor 304, connection 302, output device 322, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Clauses associated with this description include:

Clause 1. A method of comparing a first number A^{bit} with a second number B^{bit}, the method comprising: receiving, from a first computing device associated with the first number A^{bit}, a share a₁^{bit} and a share b₁^{bit}; receiving, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴, and wherein the first number A^{bit}=a₁^{bit} XOR a₂^{bit} and wherein the second number B^{bit}=b₁^{bit} XOR b₂^{bit}, wherein XOR comprises an XOR function that applies addition modulo 2 to corresponding pairs of bits of two strings; and comparing, via a comparison function that compares numbers as modulo 2⁶⁴, the first number A^{bit} and the second number B^{bit} to generate a shared output bit indicating which number is larger.

Clause 2. The method of clause 1, wherein the first number A^{bit} comprises a first 64-bit word and the second number B^{bit} comprises a second 64-bit word.

Clause 3. The method of any previous clause, wherein the share a₁^{bit} is in a 64-bit format and the share b₁^{bit} is in the 64-bit format.

Clause 4. The method of any previous clause, wherein the XOR function compares a₁^{bit} with a₂^{bit} and b₁^{bit} with b₂^{bit} on a bit-by-bit basis and not under modulo 2⁶⁴.

Clause 5. The method of any previous clause, wherein the comparison function is represented as a multivariate polynomial in terms of individual bits of A^{bit} and B^{bit}.

Clause 6. The method of any previous clause, wherein the comparison function applies a recursive approach to evaluate the multivariate polynomial.

Clause 7. The method of any previous clause, wherein the comparing, via comparison function that compares numbers as modulo 2⁶⁴, the first number A^{bit} and the second number B^{bit} to generate the shared output bit indicating which number is larger occurs on each of the first computing device and the second computing device.

Clause 8. The method of any previous clause, wherein the comparison function applies a Beaver triples technique that converts a circuit of additions and multiplications into a secure multi-party computation protocol that evaluates the circuit securely.

Clause 9. The method of any previous clause, wherein the Beaver triples technique uses three 64-bit strings R, S, T such that T−R AND S.

Clause 10. The method of any previous clause, wherein R, S and T are equivalent to 64 Beaver triples over a field GF(2).

Clause 11. The method of any previous clause, wherein the comparing is performed using pre-prepared Beaver triples and the first computing device and the second computing device use secure multi-party computation operations for each XOR and AND gate of the comparison function.

Clause 12. The method of any previous clause, wherein the comparison function is implemented as a recursively computed comparison circuit.

Clause 13. A system for comparing a first number A^{bit} with a second number B^{bit}, the system comprising: one or more processors; and one or more computer-readable memories storing instructions which, when executed by the one or more processors, cause the one or more processors to be configured to: receive, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴, and wherein the first number A^{bit}=a₁^{bit} XOR a₂^{bit} and wherein the second number B^{bit}=b₁^{bit} XOR b₂^{bit}, wherein XOR comprises an XOR function that applies addition modulo 2 to corresponding pairs of bits of two strings; and compare, via a comparison function that compares numbers as modulo 2⁶⁴, the first number A^{bit} and the second number B^{bit} to generate a shared output bit indicating which number is larger.

Clause 14. The system of clause 13, wherein the first number A^{bit} comprises a first 64-bit word and the second number B^{bit} comprises a second 64-bit word.

Clause 15. The system of any of clauses 13-14, wherein the share a₁^{bit} is in a 64-bit format and the share b₁^{bit} is in the 64-bit format.

Clause 16. The system of any of clauses 13-15, wherein the XOR function compares a₁^{bit} with a₂^{bit} and b₁^{bit} with b₂^{bit} on a bit-by-bit basis and not under modulo 2⁶⁴.

Clause 17. The system of any of clauses 13-16, wherein the comparison function is represented as a multivariate polynomial in terms of individual bits of A^{bit} and B^{bit}.

Clause 18. The system of any of clauses 13-17, wherein the comparison function applies a recursive approach to evaluate the multivariate polynomial.

Clause 19. The system of any of clauses 13-18, wherein the comparing, via comparison function that compares numbers as modulo 2⁶⁴, the first number A^{bit} and the second number B^{bit} to generate the shared output bit indicating which number is larger occurs on each of the first computing device and the second computing device.

Clause 20. The system of any of clauses 13-19, wherein the comparison function applies a Beaver triples technique that converts a circuit of additions and multiplications into a secure multi-party computation protocol that evaluates the circuit securely.

Clause 21. The system of any of clauses 13-20, wherein the Beaver triples technique uses three 64-bit strings R, S, T such that T−R AND S.

Clause 22. The system of any of clauses 13-21, wherein R, S and T are equivalent to 64 Beaver triples over a field GF(2).

Clause 23. The system any of clauses 13-22, wherein the comparing is performed using pre-prepared Beaver triples and the first computing device and the second computing device use secure multi-party computation operations for each XOR and AND gate of the comparison function.

Clause 24. The system of any of clauses 13-23, wherein the comparison function is implemented as a recursively computed comparison circuit.

What is claimed is:

1. A method of comparing a first number A^{bit} with a second number B^{bit}, the method comprising:
receiving, from a first computing device associated with the first number A^{bit}, a share a₁^{bit} and a share b₁^{bit};
receiving, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴, and wherein the first number A^{bit}=a₁^{bit} XOR a₂^{bit} and wherein the second number B^{bit}=b₁^{bit} XOR b₂^{bit}, wherein XOR comprises an XOR function that applies addition modulo 2 to corresponding pairs of bits of two strings; and
comparing, via a comparison function that compares numbers as modulo 2⁶⁴, the first number A^{bit} and the second number B^{bit} to generate a shared output bit indicating which number is larger.

2. The method of claim 1, wherein the first number A^{bit} comprises a first 64-bit word and the second number B^{bit} comprises a second 64-bit word.

3. The method of claim 2, wherein the share a₁^{bit} is in a 64-bit format and the share b₁^{bit} is in the 64-bit format.

4. The method of claim 1, wherein the XOR function compares a₁^{bit} with a₂^{bit} and b₁^{bit} with b₂^{bit} on a bit-by-bit basis and not under modulo 2⁶⁴.

5. The method of claim 1, wherein the comparison function is represented as a multivariate polynomial in terms of individual bits of A^{bit} and B^{bit}.

6. The method of claim 5, wherein the comparison function applies a recursive approach to evaluate the multivariate polynomial.

7. The method of claim 1, wherein the comparing, via comparison function that compares numbers as modulo 2⁶⁴, the first number A^{bit} and the second number B^{bit} to generate the shared output bit indicating which number is larger occurs on each of the first computing device and the second computing device.

8. The method of claim 1, wherein the comparison function applies a Beaver triples technique that converts a circuit of additions and multiplications into a secure multi-party computation protocol that evaluates the circuit securely.

9. The method of claim 8, wherein the Beaver triples technique uses three 64-bit strings R, S, T such that T−R AND S.

10. The method of claim 9, wherein R, S and T are equivalent to 64 Beaver triples over a field GF(2).

11. The method of claim 1, wherein the comparing is performed using pre-prepared Beaver triples and the first computing device and the second computing device use secure multi-party computation operations for each XOR and AND gate of the comparison function.

12. The method of claim 11, wherein the comparison function is implemented as a recursively computed comparison circuit.

13. A system for comparing a first number A^{bit} with a second number B^{bit}, the system comprising:
one or more processors; and
one or more computer-readable memories storing instructions which, when executed by the one or more processors, cause the one or more processors to be configured to:
receive, from a first computing device associated with the first number A^{bit}, a share a₁^{bit} and a share b₁^{bit};
receive, from a second computing device associated with the second number B^{bit}, a share a₂^{bit} and a share b₂^{bit}, wherein the first number A^{bit}=a₁^{bit}+a₂^{bit} mod 2⁶⁴ and wherein the second number B^{bit}=b₁^{bit}+b₂^{bit} mod 2⁶⁴, and wherein the first number A^{bit}=a₁^{bit} XOR a₂^{bit} and wherein the second number B^{bit}=b₁^{bit} XOR b₂^{bit}, wherein XOR comprises an XOR function that applies addition modulo 2 to corresponding pairs of bits of two strings; and
compare, via a comparison function that compares numbers as modulo 2⁶⁴, the first number A^{bit} and the second number B^{bit} to generate a shared output bit indicating which number is larger.

14. The system of claim 13, wherein the first number A^{bit} comprises a first 64-bit word and the second number B^{bit} comprises a second 64-bit word.

15. The system of claim 14, wherein the share a₁^{bit} is in a 64-bit format and the share b₁^{bit} is in the 64-bit format.

16. The system of claim 13, wherein the XOR function compares a₁^{bit} with a₂^{bit} and b₁^{bit} with b₂^{bit} on a bit-by-bit basis and not under modulo 2⁶⁴.

17. The system of claim 13, wherein the comparison function is represented as a multivariate polynomial in terms of individual bits of A^{bit} and B^{bit}.

18. The system of claim 17, wherein the comparison function applies a recursive approach to evaluate the multivariate polynomial.

19. The system of claim 13, wherein the comparing, via comparison function that compares numbers as modulo 2⁶⁴, the first number A^{bit} and the second number B^{bit} to generate the shared output bit indicating which number is larger occurs on each of the first computing device and the second computing device.

20. The system of claim 13, wherein the comparison function applies a Beaver triples technique that converts a circuit of additions and multiplications into a secure multi-party computation protocol that evaluates the circuit securely.

21. The system of claim 20, wherein the Beaver triples technique uses three 64-bit strings R, S, T such that T−R AND S.

22. The system of claim 21, wherein R, S and T are equivalent to 64 Beaver triples over a field GF(2).

23. The system of claim 13, wherein the comparing is performed using pre-prepared Beaver triples and the first computing device and the second computing device use secure multi-party computation operations for each XOR and AND gate of the comparison function.

24. The system of claim 23, wherein the comparison function is implemented as a recursively computed comparison circuit.
